(19) United States
(12) Patent Application Publication
(10) Pub. No.: US 2025/0139668 A1
(43) Pub. Date: May 1, 2025

(54) RETARGETING ADVERTISEMENT SERVICE METHOD, AND DEVICE AND SYSTEM FOR IMPLEMENTING SAME

(71) Applicant: MOTOV CO., LTD., Incheon (KR)

(72) Inventors: Seong Hoon KIM, Sejong (KR); Woo Hyeok LIM, Seoul (KR); Nam Young HEO, Chuncheon-si (KR)

(73) Assignee: MOTOV CO., LTD., Incheon (KR)

(21) Appl. No.: 18/941,861

(22) Filed: Nov. 8, 2024

Related U.S. Application Data
(63) Continuation of application No. PCT/KR2023/006188, filed on May 8, 2023.

(30) Foreign Application Priority Data
May 10, 2022 (KR) 10-2022-0057142

(51) Int. Cl. G06Q 30/0273; G06Q 30/0251

(52) U.S. Cl. CPC G06Q 30/0275; G06Q 30/0255

(57) ABSTRACT

A retargeting advertisement service method according to an embodiment of the present invention includes collecting, by an advertisement targeting server, advertisement ID information and identification information from each of a plurality of terminals that have acquired an advertisement ID transmitted by a digital advertising medium, performing, by a bidding participation device, clustering using the information collected by the advertisement targeting server and transmitting information regarding a user group of a size exceeding a threshold, generated as a result of the clustering, to a bidding generation device, determining, by the bidding generation device, whether to generate real-time bidding (RTB) for a retargeting advertisement for the transmitted user group, based on the information regarding the transmitted user group, and performing, by the bidding participation device, the RTB when an advertisement media generation event occurs on a first terminal belonging to the user group.

### CROSS-REFERENCE TO RELATED APPLICATIONS

The present application is a continuation of International Patent Application No. PCT/KR2023/006188 filed on May 8, 2023, which is based upon and claims the benefit of priority to Korean Patent Application No. 10-2022-0057142 filed on May 10, 2022. The disclosures of the above-listed applications are hereby incorporated by reference herein in their entirety.

### TECHNICAL FIELD

The present invention relates to a retargeting advertisement service method and a device and system for implementing the same, and more specifically, to a retargeting advertisement service method for providing retargeting advertisements through real-time bidding (RTB) by utilizing advertisement access information of a user terminal, and a device and system for implementing the same.

### BACKGROUND ART

Retargeting advertisements are a type of advertisement aimed at increasing advertising effectiveness by inducing visits from interested users, who are relatively likely to convert, through marketing activities such as search advertisements, and then exposing advertisements for products of particular interest to these users through retargeting media.

Recently, to provide retargeting advertisement services, instead of simply displaying advertisements via pop-ups or manual methods when visiting a website, a bidding method has been used that matches advertisements sold by advertisers to suitable media in real-time through real-time bidding (RTB) between advertisers purchasing media for displaying advertisements and publishers selling the media for advertisements.

In the case of using such an RTB method, publishers can maximize their advertising revenue, while advertisers can optimize the exposure of their advertisements for each advertisement provided.

However, in providing retargeting advertisement services, while it is important to appropriately match advertisers and publishers through RTB, it is even more critical to select a target user group that can improve purchase conversion rates through the provision of retargeting advertisements.

Conventionally, to select an appropriate target user group for advertisements, methods have been used that rely solely on fragmentary information, such as whether specific keywords were searched through search engines or whether advertisements were encountered through televisions, websites, or applications.

However, with the rapid advancement of technology, new media for delivering advertisements, such as digital signage alongside traditional media like televisions, websites, and applications, have emerged.

Digital signage is provided either as fixed installations in large buildings with high foot traffic or in places where people stay for a certain period, or as mobile installations in taxis, buses, subways, and other forms of mobility. Through this, advertising content can be provided to an unspecified large number of terminals.

Therefore, when providing retargeting advertisement services, it is necessary to utilize information not only regarding users who encountered advertisements via websites or applications but also regarding users who encountered advertisements via digital signage installed in buildings, taxis, buses, subways, etc.

Additionally, there is a demand for technologies that can analyze the history of advertisements encountered by users during their movements via devices such as smartphones or tablets, enabling the selection of more appropriate target user groups and utilizing this information in RTB.

### DISCLOSURE

### Technical Problems

A technical problem to be solved by the present invention is to provide a retargeting advertisement service method, and a device and system for implementing the same, that can select an appropriate target user group for retargeting advertisements by utilizing the history of advertisements encountered by a user during movement.

Another technical problem to be solved by the present invention is to provide a retargeting advertisement service method, and a device and system for implementing the same, that can provide optimal advertisements capable of improving purchase conversion rates by utilizing the history of advertisements encountered by a user during movement in real-time bidding (RTB) between publishers and advertisers.

The technical problems of the present invention are not limited to the technical problems mentioned above, and other technical problems not mentioned will be clearly understood by those skilled in the art from the description below.

### Technical Solutions

To address the aforementioned technical problems, a retargeting advertisement service method according to an embodiment of the present invention includes collecting, by an advertisement targeting server, advertisement ID information and identification information from each of a plurality of terminals that have acquired an advertisement ID transmitted by a digital advertising medium, performing, by a bidding participation device, clustering using the information collected by the advertisement targeting server and transmitting information regarding a user group of a size exceeding a threshold, generated as a result of the clustering, to a bidding generation device, determining, by the bidding generation device, whether to generate real-time bidding (RTB) for a retargeting advertisement for the transmitted user group, based on the information regarding the transmitted user group, and performing, by the bidding participation device, the RTB when an advertisement media generation event occurs on a first terminal belonging to the user group.

In one embodiment, the collecting the advertisement ID information and the identification information from each of the plurality of terminals that have acquired an advertisement ID transmitted by the digital advertising medium may further include collecting additional information generated during movement of each of the plurality of terminals, and the additional information may include whether a single or multiple predetermined advertisement IDs have been acquired, location information and time information at which the advertisement IDs have been acquired, and user profile information.

In one embodiment, when the digital advertising medium is a wireless device capable of wireless communication, the additional information may include information regarding means of connection to the digital advertising medium when each of the plurality of terminals acquires an advertisement ID from the digital advertising medium. At this time, the information regarding the connection means may include, for example, wireless communication connection information such as Wi-Fi, Bluetooth, Zigbee, or Near Field Communication (NFC), as well as connection information such as barcodes and QR codes.

Additionally, when the digital advertising medium 40 is an outdoor medium that does not support wireless communication, the additional information may include the advertisement transmission history of the outdoor medium and information regarding each user's movement trajectory, which includes each user's movement information based on time and location.

In one embodiment, the performing clustering using the information collected by the advertisement targeting server and transmitting information regarding a user group of a size exceeding a threshold, generated as a result of the clustering, to the bidding generation device may include performing clustering into a plurality of user groups based on the advertisement ID information, the identification information, and the additional information, and determining a user group of a size exceeding the threshold among the clustered user groups.

In one embodiment, the digital advertising medium may include a display mounted on mobility.

In one embodiment, the performing the RTB when an advertisement media generation event occurs on the first terminal belonging to the user group may include performing the RTB when an application execution or website access event occurs on the first terminal in accordance with user action.

In one embodiment, the performing the RTB when an advertisement media generation event occurs on the first terminal belonging to the user group may include transmitting, by the bidding participation device, a push notification to the first terminal to induce the occurrence of the advertisement media generation event.

In one embodiment, the performing the RTB when an advertisement media generation event occurs on the first terminal belonging to the user group may include receiving, by the bidding participation device, advertisement access history, near-future transmission information, and user profile information of the first terminal stored in the advertisement targeting server, and calculating, using the received information, a user behavior conversion probability and RTB success probability at the first terminal.

In one embodiment, the advertisement access history may include advertisement access frequency and advertisement access timestamp information corresponding to a movement path of the first terminal.

In one embodiment, the user behavior conversion probability may be a probability of occurrence of a click event, a download event, and a purchase conversion event for an advertisement provided through an application or website on the first terminal.

In one embodiment, the performing the RTB when an advertisement media generation event occurs on the first terminal belonging to the user group may include receiving requirements of an advertiser participating in the RTB; and selecting and providing a retargeting advertisement that meets the advertiser's requirements.

In one embodiment, the advertiser's requirements may include information regarding a user's gender, age group, areas of interest, types of applications installed by the user, a time of last application execution, and a list of products recently purchased by the user.

To address the aforementioned technical problems, a retargeting advertisement service system according to an embodiment of the present invention includes an advertisement targeting server collecting advertisement ID information and identification information from each of a plurality of terminals that have acquired an advertisement ID transmitted by a digital advertising medium, a bidding participation device performing clustering using the information collected by the advertisement targeting server and transmitting information regarding a user group of a size exceeding a threshold, generated as a result of the clustering, to a bidding generation device, and the bidding generation device determining whether to generate RTB for a retargeting advertisement for the transmitted user group, based on the information regarding the transmitted user group, wherein the bidding participation device performs the RTB when an advertisement media generation event occurs on a first terminal belonging to the user group.

In one embodiment, the advertisement targeting server may collect additional information generated during movement of each of the plurality of terminals, and the additional information may include whether a single or multiple predetermined advertisement IDs have been acquired, location information and time information at which the advertisement IDs have been acquired, and user profile information.

In one embodiment, the bidding participation device may perform clustering into a plurality of user groups based on the advertisement ID information, the identification information, and the additional information, and determines a user group of a size exceeding the threshold among the clustered user groups.

In one embodiment, the bidding participation device may perform the RTB when an application execution or website access event occurs on the first terminal in accordance with user action.

In one embodiment, the bidding participation device may transmit a push notification to the first terminal to induce the occurrence of the advertisement media generation event.

In one embodiment, the bidding participation device may receive advertisement access history, near-future transmission information, and user profile information of the first terminal stored in the advertisement targeting server, and may calculate, using the received information, a user behavior conversion probability and an RTB success probability at the first terminal.

The advertisement access history may include advertisement access frequency and advertisement access timestamp information corresponding to a movement path of the first terminal.

The user behavior conversion probability may be a probability of occurrence of a click event, a download event, and a purchase conversion event for an advertisement provided through an application or website on the first terminal.

### BRIEF DESCRIPTION OF DRAWINGS

FIG. 1 is a block diagram of a retargeting advertisement service system according to an embodiment of the present invention.

FIGS. 2 through 4 are examples illustrating the flow of operations among respective devices for providing a retargeting advertisement service method according to an embodiment of the present invention.

FIG. 5 is an example of acquiring advertisement IDs transmitted from digital advertising media at a plurality of terminals according to some embodiments of the present invention.

FIG. 6 is an example of storing information collected during the movement of each of a plurality of terminals at an advertisement targeting server according to some embodiments of the present invention.

FIG. 7 is an example of generating RTB for a retargeting advertisement for a meaningful user group by clustering multiple user terminals according to some embodiments of the present invention.

FIG. 8 is an example of performing RTB upon the occurrence of an advertisement media generation event at a specific terminal according to some embodiments of the present invention.

FIG. 9 is a hardware configuration diagram of an exemplary computing device capable of implementing the methods according to some embodiments of the present invention.

### BEST MODES FOR CARRYING OUT THE INVENTION

Preferred embodiments of the present disclosure will hereinafter be described in detail with reference to the accompanying drawings. The advantages and features of the present disclosure, and the methods for achieving them, will become apparent with reference to the embodiments described below in detail together with the accompanying drawings. However, the technical scope of the present disclosure is not limited to the following embodiments but can be implemented in various forms. The following embodiments are provided merely to fully describe the technical scope of the present disclosure and to fully inform those skilled in the art to which the present disclosure pertains of its scope. The technical scope of the present disclosure is defined only by the claims.

When adding reference numerals to components in each drawing, it should be noted that, where possible, the same numerals are used for the same components, even if they are depicted in different drawings. Furthermore, in describing the present disclosure, detailed explanations of related known configurations or functions may be omitted if it is determined that such details could obscure the gist of the present disclosure.

Unless otherwise defined, all terms (including technical and scientific terms) used herein can be interpreted as having meanings commonly understood by those skilled in the art to which the present disclosure pertains. Terms generally defined in dictionaries are not ideally or excessively interpreted unless explicitly defined otherwise. The terms used herein are intended to describe the embodiments and are not intended to limit the present disclosure. Singular terms used herein include plural forms unless specifically stated otherwise.

Additionally, in describing the components of the present disclosure, terms such as first, second, A, B, (a), (b), and the like may be used. These terms are used merely to distinguish one component from another and do not limit the nature, sequence, or order of the components. When a component is described as being “connected,” “coupled,” or “linked” to another component, it should be understood that the component may be directly connected or linked to the other component, or another component may be “connected,” “coupled,” or “linked” between them.

The terms “comprises” and/or “comprising” as used in this specification do not exclude the presence or addition of one or more other components, steps, actions, and/or elements in addition to the stated components, steps, actions, and/or elements.

Some embodiments of the present disclosure will hereinafter be described in detail with reference to the accompanying drawings.

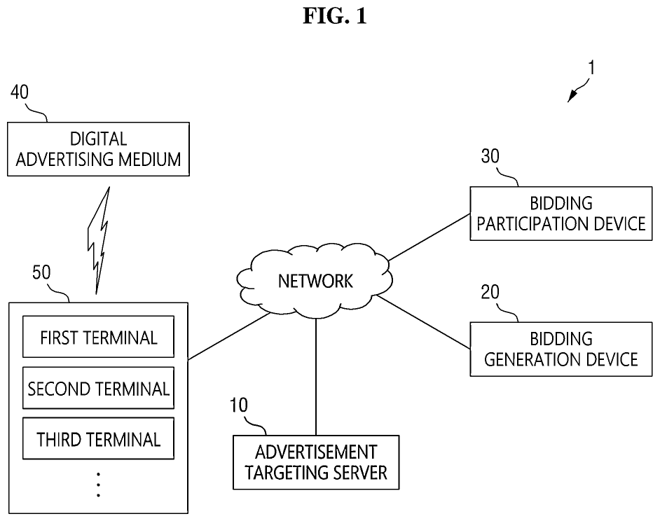

FIG. 1 is a block diagram of a retargeting advertisement service system according to an embodiment of the present invention. Referring to FIG. 1, the retargeting advertisement service system according to an embodiment of the present invention includes a digital advertising medium 40, a plurality of terminals 50, an advertisement targeting server 10, a bidding generation device 20, and a bidding participation device 30.

Each of the plurality of terminals 50, which is a device that provides an environment in which applications can be installed and executed, may be implemented as a display device such as a smartphone, tablet, PC, or laptop.

The digital advertising medium 40 may be implemented as a digital signage device that provides advertising content in the form of video and audio. The digital advertising device 20 may be installed and operated, for example, on the exterior or interior wall of a large building with high foot traffic, such as a terminal, government office, bus stop, department store, subway, airport, hotel, or hospital, or in a location where people stay for a certain period, such as an elevator, exhibition hall, movie theater, restaurant, shopping mall, or store.

Additionally, the digital advertising medium 40 may be mounted on a mobile transportation means such as mobility. Furthermore, a mobile device such as a smartphone or tablet may also serve as the digital advertising medium 40.

The advertisement targeting server 10 may be connected to the plurality of terminals 50 and the bidding participation device 30 through a network to collect and manage information regarding advertisements accessed on each of the plurality of terminals 50 and provide the collected information to the bidding participation device 30. The advertisement targeting server 10 may be, for example, a data management platform (DMP), which is a platform that collects data related to advertisements accessed on users' terminals and sells information for retargeting to advertisers or agencies. The data collected by the DMP may include, for example, advertisement delivery information based on time and location, such as location information of outdoor media, information on the type of location (sports stores, restaurants, hospitals, bus stops, etc.), and advertisement transmission history information. From this, the user's movement trajectory for each terminal can be utilized to estimate the probability that the user has directly encountered individual advertisements transmitted from outdoor media.

In one embodiment, upon receiving an advertisement ID transmitted by the digital advertising medium 40, each of the plurality of terminals 50 may display an alarm message notifying the receipt of the advertisement ID on the screen. By selecting the alarm message, the application may be automatically executed to display advertising content corresponding to the received advertisement ID. At this time, each terminal may store a history of displaying the advertising content corresponding to the advertisement ID through the application and provide related information to the advertisement targeting server 10.

In another embodiment, when an alarm message notifying the receipt of an advertisement ID is displayed on each of the plurality of terminals 50, and the alarm message is selected to obtain detailed information on the advertisement, the advertisement targeting server 10 may be automatically accessed. At this time, the advertisement targeting server 10 may automatically collect the terminal ID and advertisement ID from each terminal.

Accordingly, the advertisement targeting server 10 may collect and store information on which terminal's user has viewed the advertising content of a specific advertisement ID.

The bidding participation device 30 may select a target user group for providing a retargeting advertisement using the information collected by the advertisement targeting server 10.

Additionally, the bidding participation device 30 may perform a function of providing information regarding the target user group required for performing RTB for the retargeting advertisement to the bidding generation device 20.

Here, the bidding generation device 20 is a server managed by an operator selling media for advertising and finding advertisements to be exposed, on behalf of publishers that actually sell the media. The bidding generation device 20 may be, for example, a supply-side platform (SSP), an ad server, or a header bidding intermediary server. In one embodiment, the bidding generation device 20 may be implemented as a web page or application itself.

The bidding participation device 30, which is a server managed by an operator selling advertisements and finding appropriate media to expose advertisements, on behalf of advertisers that actually purchase the media, may provide advertisements registered by advertisers to each of the plurality of terminals 50. The bidding participation device 30 may be, for example, a demand-side platform (DSP) or a general server capable of participating in bidding.

In one embodiment, the bidding generation device 20 and the bidding participation device 30 may each be implemented as a computing device or as a single module performing computing operations.

The bidding generation device 20 may determine whether to generate RTB for the retargeting advertisement for the target user group based on the information regarding the target user group transmitted from the bidding participation device 30.

Accordingly, when the bidding generation device 20 decides to generate RTB for the retargeting advertisement, the bidding participation device 30 performs RTB to provide the retargeting advertisement to the target user group.

In one embodiment, when an advertisement media generation event occurs at a first terminal belonging to the target user group, the bidding participation device 30 may perform RTB to select and provide the retargeting advertisement to be displayed through the advertisement medium generated at the first terminal.

As described above, according to the configuration of the system in the embodiment of the present invention, it is possible to select an appropriate target user group for the retargeting advertisement by utilizing the history of advertisements encountered by users during movement and to apply this during RTB performed between publishers and advertisers.

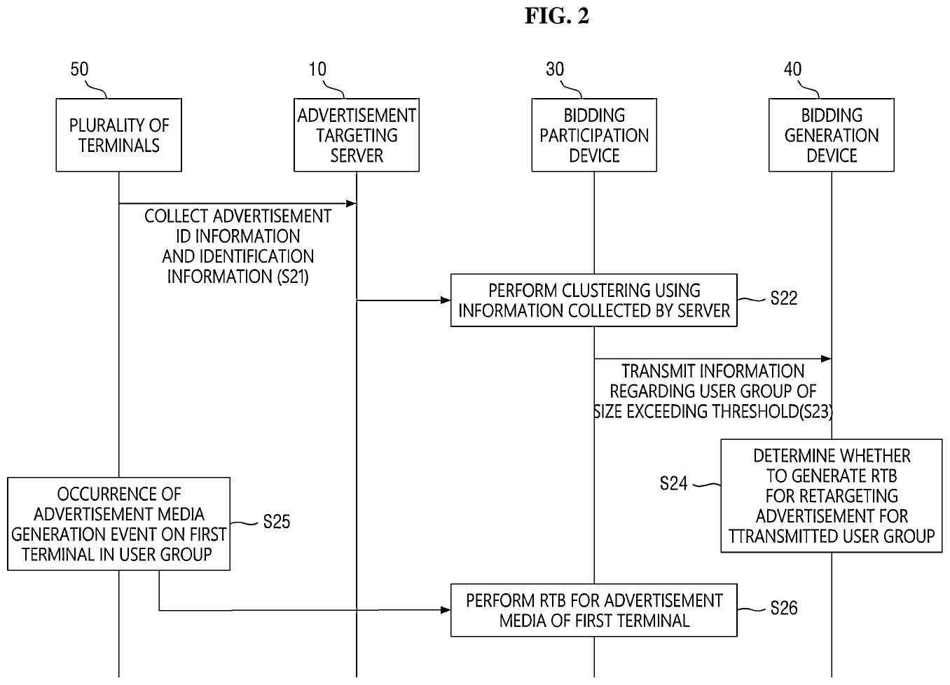

FIGS. 2 through 4 are examples illustrating the flow of operations among respective devices for providing a retargeting advertisement service method according to an embodiment of the present invention.

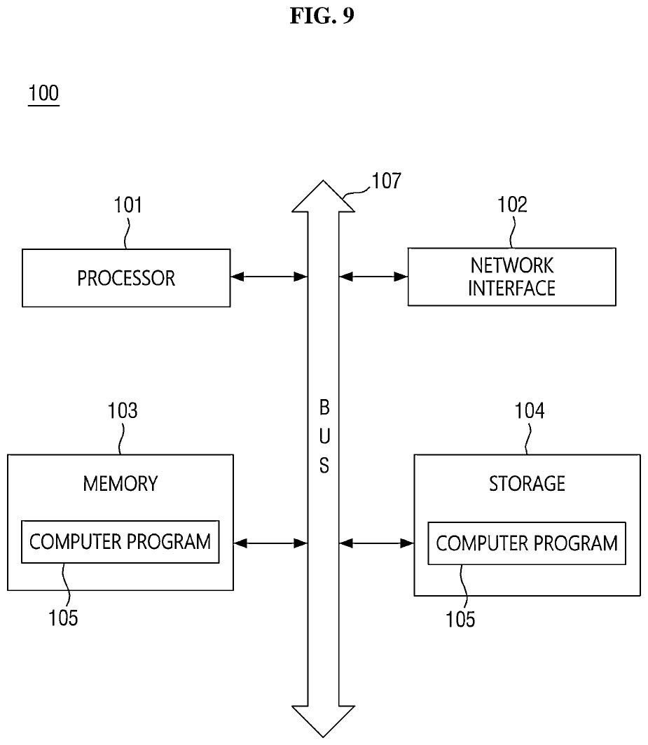

The retargeting advertisement service method according to an embodiment of the present invention may be executed by the retargeting advertisement service system 1 of FIG. 1, and each device constituting the retargeting advertisement service system 1 may be implemented as a computing device 100 of FIG. 9.

Referring to FIG. 2, first, in operation S21, the advertisement targeting server 10 collects the advertisement ID obtained by each of the plurality of terminals 50 from the digital advertising medium 40 and the identification information of each terminal. The digital advertising medium 40 may include not only fixed digital signage installed on the exterior wall of a building or inside an exhibition hall but also a display mounted on mobility such as a taxi or subway.

At this time, the advertisement targeting server 10 may further collect additional information generated during the movement of each terminal along with an advertisement ID and identification information of each terminal. The additional information may include, for example, whether a single or multiple predetermined advertisement IDs have been obtained, location information where the advertisement IDs have been obtained, time information when the advertisement IDs have been obtained, and user profile information.

In one embodiment, when the digital advertising medium is a wireless device capable of wireless communication, information regarding means of connection to the digital advertising medium 40 may be collected as additional information when each of the plurality of terminals obtains an advertisement ID from the digital advertising medium 40. At this time, the information regarding the connection means may include, for example, wireless communication connection information such as Wi-Fi, Bluetooth, Zigbee, or Near Field Communication (NFC), as well as connection information such as barcodes and QR codes.

The additional information collected in this manner may be used to estimate the number of times the advertisement ID is exposed (or the number of impressions) for each terminal.

In one embodiment, when the digital advertising medium 40 is an outdoor medium that does not support wireless communication, the advertisement transmission history of the outdoor medium and information regarding each user's movement trajectory, which includes each user's movement information based on time and location may be collected as additional information.

Accordingly, based on the location of the outdoor medium, spatially effective points where the outdoor medium can be viewed may be determined, and the probability that each user may have encountered a specific advertisement may be calculated by joining information based on time and location using each user's movement trajectory information at the effective points. This probability information may be used to select retargeting targets.

Thereafter, in operation S22, the bidding participation device 30 performs clustering using the information collected by the advertisement targeting server 10.

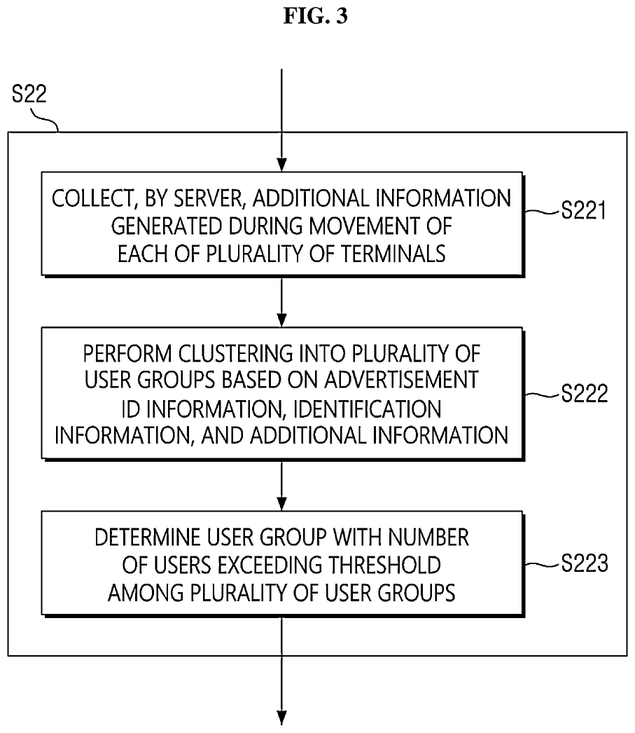

Referring to FIG. 3, in performing operation S22, the advertisement targeting server 10 may collect additional information generated during the movement of each of the plurality of terminals 50 (S221), and the bidding participation device 30 may cluster the plurality of terminals 50 into multiple user groups based on the advertisement ID, identification information of each terminal, and the additional information collected by the advertisement targeting server 10 (S222). Through clustering the plurality of terminals 50, the bidding participation device 30 may select a meaningful user group that is highly likely to view follow-up advertisements among the users who have previously viewed the specific advertisement. For example, a group with the number of users exceeding a preset threshold may be selected as the meaningful user group from among the clustered user groups.

At this time, the bidding participation device 30 may determine the user group with a number of users exceeding the threshold among the clustered user groups as a target user group (S223).

For example, if it is analyzed that the age group of users who have most frequently viewed a specific advertisement near Gangnam Station is in their 20s and 30s, users in their 20s and 30s near Gangnam Station may be set as the meaningful user group, and a retargeting advertisement may be provided to the selected user group.

In operation S23, the bidding participation device 30 transmits information regarding the target user group, which is a user group with the number of users exceeding the threshold among the multiple user groups generated as a result of clustering performed in operation S22, to the bidding generation device 20.

Thereafter, in operation S24, the bidding generation device 20 determines whether to generate RTB for a retargeting advertisement for the target user group based on the information regarding the target user group transmitted from the bidding participation device 30. Here, the bidding generation device 20 may be, for example, an SSP, an ad server, or a header bidding intermediary server, or may be implemented as a web page or a mobile application itself.

At this time, to determine whether to generate RTB for the retargeting advertisement, the bidding generation device 20 may additionally determine whether the information regarding the target user group satisfies preset RTB generation requirements. The RTB generation requirements may include, for example, conditions regarding each user's age, gender, location, and the number of advertisement accesses, which are preset by the bidding generation device 20 to select advertisements suitable for the medium.

In other words, even if the target user group is determined by the bidding participation device 30, the bidding generation device 20 may decide not to generate RTB if the target user group does not meet the RTB generation requirements set by policy.

Finally, in operation S25, when an advertisement media generation event occurs at a first user terminal belonging to the target user group among the plurality of terminals 50, the bidding participation device 30 performs RTB for the advertisement medium generated at the first user terminal in operation S26. At this time, the advertisement media generation event may include an application execution or website access event caused by a user action.

In other words, the bidding participation device 30 performs RTB to find an advertisement to be exposed through the advertisement medium generated at the first user terminal, and when an appropriate advertisement is successfully bid for through RTB, the corresponding advertisement is displayed through the advertisement medium of the first user terminal.

In one embodiment, the bidding participation device 30 may send a push notification to the first user terminal to induce the occurrence of an advertisement media generation event, and accordingly, the first user terminal may execute the application or access the website through the push notification displayed on the screen.

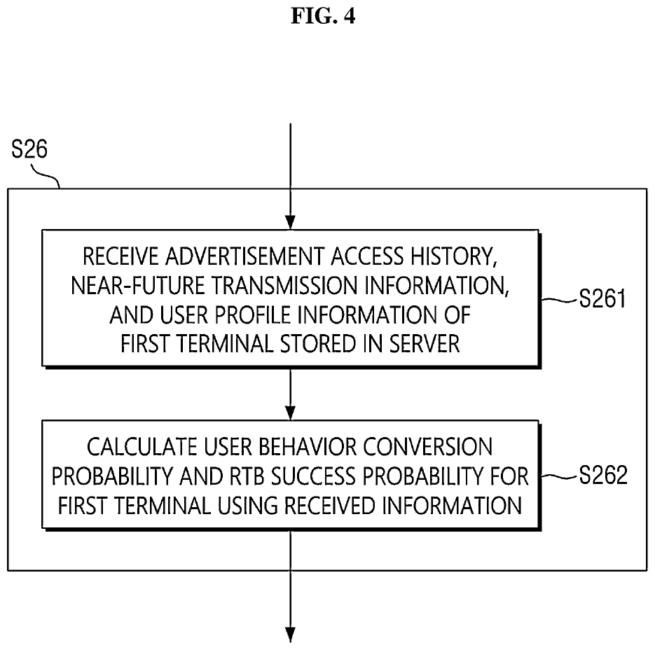

In one embodiment, referring to FIG. 4, in performing operation S26, the bidding participation device 30 may receive the advertisement access history of the first user terminal stored in the advertisement targeting server 10, near-future transmission information, and user profile (S261). Here, the advertisement access history may include the frequency of accessing advertisements and advertisement access timestamp information for advertisements accessed by the first user terminal during its movement. At this time, the frequency of accessing advertisements may include the total number of advertisements accessed during movement, the frequency of accessing the same advertisements, and the frequency of accessing similar advertisements.

In addition, in performing operation S26, the bidding participation device 30 may calculate the user behavior conversion probability and the RTB success probability of the user of the first user terminal using the received information (S262).

Here, the user behavior conversion probability refers to the probability of occurrence of click events, download events, and purchase conversion events for advertisements provided through the advertisement medium (e.g., application or website) generated at the first user terminal.

Additionally, the RTB success probability refers to the probability that advertisers will successfully place their advertisements through the advertisement medium generated at the first user terminal.

In other words, in performing RTB for the advertisement medium generated at the first user terminal, the bidding participation device 30 calculates the user behavior conversion probability and the RTB success probability and selects an optimal advertisement to increase the purchase conversion rate for the first user terminal based on these probabilities.

According to the embodiment of the present invention as described above, it is possible to select an appropriate target user group for a retargeting advertisement by utilizing the history of advertisements encountered by each user during movement. Furthermore, by utilizing the history of advertisements encountered by each user during movement in RTB between publishers and advertisers, an optimal advertisement capable of improving purchase conversion rates can be provided.

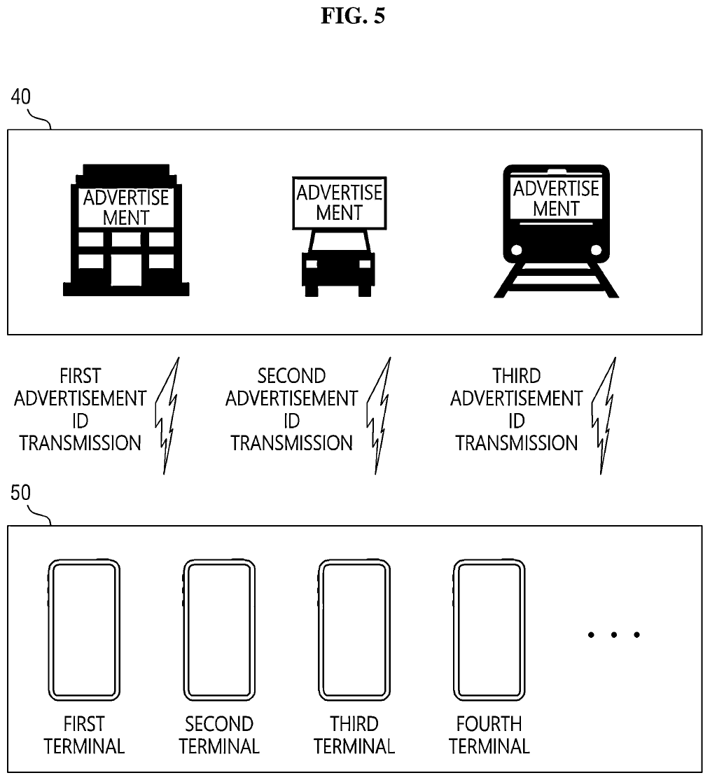

FIG. 5 is an example of acquiring advertisement IDs transmitted from digital advertising media at a plurality of terminals according to some embodiments of the present invention. Referring to FIG. 5, each of the plurality of terminals 50 acquires the advertisement ID of an advertisement transmitted by the digital advertising medium 40.

The digital advertising medium 40 serves as a means for displaying advertisements provided by advertisers and may be implemented as, for example, digital signage installed on the exterior wall of a building, a display mounted on the top area of a taxi, or a display attached to the outer or inner surface of a subway or bus.

Each of the plurality of terminals 50, during its movement, may acquire advertisement IDs transmitted by multiple digital advertising media 40 that it accesses at different locations. At this time, each of the plurality of terminals 50 may acquire multiple advertisement IDs during movement, and if it encounters the same advertisement at different locations, it may repeatedly acquire the same advertisement ID.

Additionally, each of the plurality of terminals 50 may acquire and store information regarding the location and time at which each advertisement ID has been acquired during its movement.

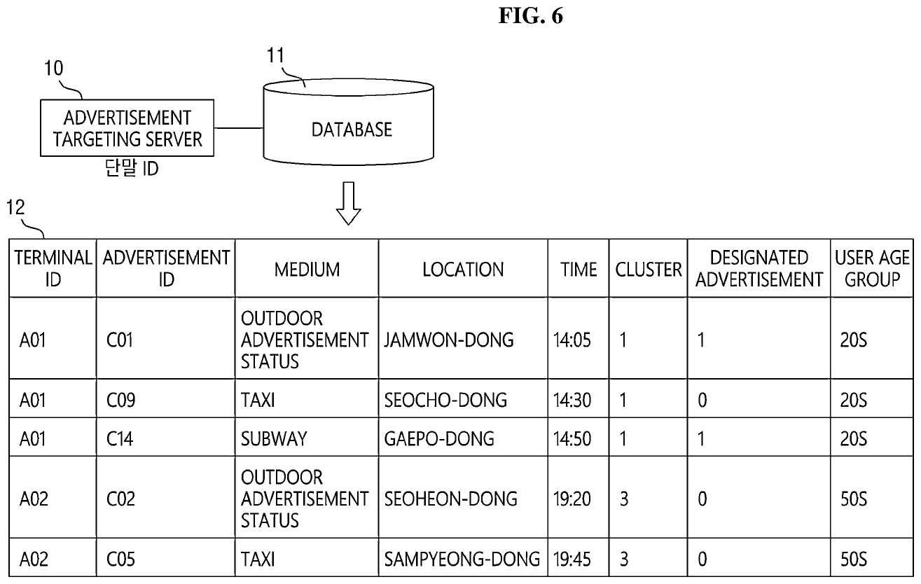

FIG. 6 is an example of storing information collected during the movement of each of a plurality of terminals at an advertisement targeting server according to some embodiments of the present invention. Referring to FIG. 6, the advertisement targeting server 10 collects the advertisement IDs acquired by each of the plurality of terminals 50 in FIG. 5, the identification information of each terminal, and additional information, and stores and manages these collected data in a database 11. Here, the additional information may include, for example, whether a single or multiple predetermined advertisement IDs have been acquired, location and time information of each advertisement ID acquisition, and user profile information.

The information collected by the advertisement targeting server 10 from each of the plurality of terminals 50 may be stored in the database 11 in the form of a table 12. At this time, each field of the table 12 may consist of, for example, terminal ID, advertisement ID, medium, location, time, cluster, whether each advertisement is a designated advertisement, user age group, etc.

For example, for a terminal with terminal ID “A01,” advertisement IDs “C01,” “C09,” and “C14,” collected from different locations, may be stored, along with basic information such as the location and time where each advertisement ID has been collected, the type of medium that has transmitted each advertisement ID, whether the advertisement is designated, and the age group of the terminal's user.

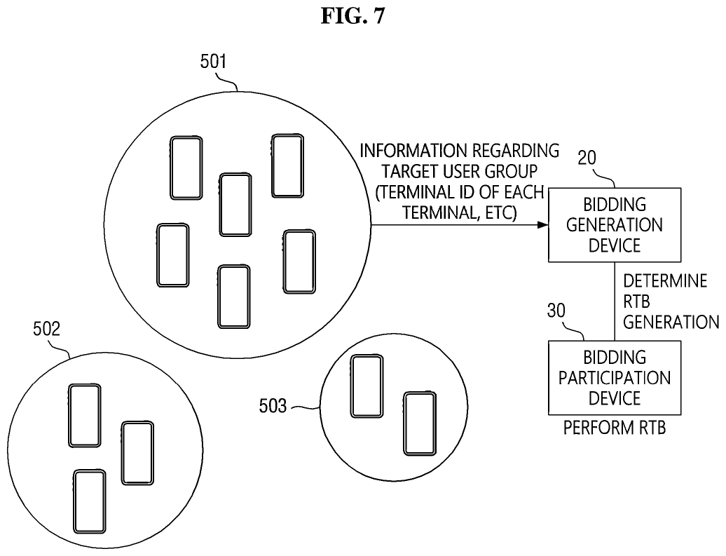

FIG. 7 is an example of generating RTB for a retargeting advertisement for a meaningful user group by clustering multiple user terminals according to some embodiments of the present invention. Referring to FIG. 7, the bidding participation device 30 may perform clustering of the plurality of terminals 50 using the advertisement IDs, identification information, and additional information collected from each of the plurality of terminals 50. The bidding participation device 30 may consider one of a plurality of user groups 501, 502, and 503 generated through clustering with the number of users exceeding a preset threshold as a meaningful user group, and may determine the meaningful user group as a target user group.

Accordingly, the bidding participation device 30 may transmit information regarding the target user group 501 determined through clustering to the bidding generation device 20, and the bidding generation device 20 may determine whether to generate RTB for a retargeting advertisement using the information regarding the target user group 501. The information regarding the target user group may include, for example, the terminal ID of each terminal belonging to the target user group, and advertisement IDs and additional information collected for each terminal ID.

When the bidding generation device 20 determines to generate RTB for a retargeting advertisement, the bidding participation device 30 may perform RTB to provide a retargeting advertisement to each terminal belonging to the target user group.

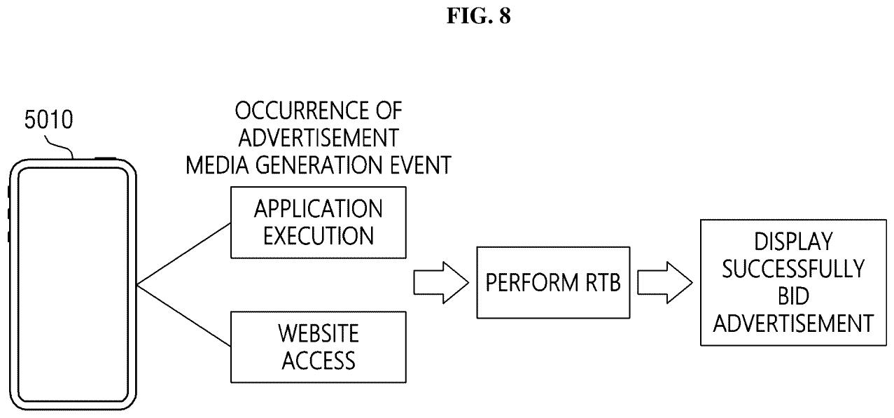

FIG. 8 is an example of performing RTB upon the occurrence of an advertisement media generation event at a specific terminal according to some embodiments of the present invention. Referring to FIG. 8, the bidding participation device 30 performs RTB to provide a retargeting advertisement for a specific terminal 5010 among the multiple terminals belonging to the target user group 501 determined through the embodiment of FIG. 7.

For example, when an advertisement media generation event, such as application execution or website access, occurs at the specific terminal 5010 belonging to the target user group 501, the bidding participation device 30 may perform RTB to select a retargeting advertisement to be provided through the advertisement medium (application or website) generated at the specific terminal 5010. The bidding participation device 30 may use RTB to match an appropriate retargeting advertisement in real-time for display through the advertisement medium generated at the specific terminal 5010.

At this time, the bidding participation device 30 may receive information regarding advertiser requirements for participating in RTB and select and provide a retargeting advertisement that meets these requirements. Here, the advertiser requirements may include, for example, information regarding the user's gender, age group, areas of interest, types of applications installed by the user, the time of the last application execution, and a list of products recently purchased by the user.

Accordingly, by performing RTB, the retargeting advertisement successfully bid for in real-time can be displayed on the advertisement medium of the specific terminal 5010.

FIG. 9 is a hardware configuration diagram of an exemplary computing device capable of implementing the methods according to some embodiments of the present invention. Each device constituting the retargeting advertisement service system 1 described earlier with reference to FIG. 1 may be implemented as the computing device 100 illustrated in FIG. 9.

As illustrated in FIG. 9, the computing device 100 may include at least one processor 101, a bus 107, a network interface 102, a memory 103 that loads a computer program 105 executed by the processor 101, and a storage 104 that stores the computer program 105. However, only components relevant to the embodiments of the present invention are illustrated in FIG. 9. Therefore, those skilled in the art will understand that additional general-purpose components may also be included beyond the components illustrated in FIG. 9.

The processor 101 controls the overall operation of the components of the computing device 100. The processor 101 may include at least one of a central processing unit (CPU), a micro processor unit (MPU), a micro controller unit (MCU), a graphics processing unit (GPU), or any other type of processor well known in the technical field of the present invention. Additionally, the processor 101 may perform computations for at least one application or program to execute the methods/operations according to various embodiments of the present invention. The computing device 100 may be equipped with one or more processors.

The memory 103 stores various data, commands, and/or information. To execute the methods/operations according to various embodiments of the present invention, the memory 103 may load one or more programs 105 from the storage 104. For example, when the computer program 105 is loaded into the memory 103, logic (or modules) may be implemented on the memory 103. An example of the memory 103 may be, but is not limited to a RAM.

The bus 107 provides communication functions between the components of the computing device 100. The bus 107 may be implemented in various forms such as an address bus, data bus, and control bus.

The network interface 102 supports wired and wireless internet communication for the computing device 100. The network interface 102 may also support various communication methods other than internet communication. For this purpose, the network interface 102 may include a communication module well known in the technical field of the present invention.

The storage 104 may non-transiently store one or more computer programs 105. The storage 104 may include a non-volatile memory such as a flash memory, hard disks, removable disk, or any other type of computer-readable recording medium well known in the technical field of the present invention.

The computer program 105 may include one or more instructions implementing the methods/operations according to various embodiments of the present invention. When the computer program 105 is loaded into the memory 103, the processor 101 may execute the instructions to perform the methods/operations according to various embodiments of the present invention.

In one embodiment, when the advertisement targeting server 10 in the configuration of the retargeting advertisement service system 1 is implemented as a computing device, the computer program 105 may include instructions for the operation of collecting advertisement ID information and identification information from each of a plurality of terminals that have acquired advertisement IDs transmitted by digital advertising media.

In one embodiment, when the bidding participation device 30 in the configuration of the retargeting advertisement service system 1 is implemented as a computing device, the computer program 105 may include instructions for the operations of performing clustering using information collected by the advertisement targeting server 10, and transmitting information regarding a user group of a size exceeding a threshold size, generated as a result of clustering, to the bidding generation device 20.

At this time, when performing clustering using the information collected by the advertisement targeting server 10, the computer program 105 may include instructions for the operations of performing clustering into a plurality of user groups based on advertisement ID information, identification information, and additional information, and determining a user group of a size exceeding the threshold size among the clustered user groups.

In one embodiment, when the bidding generation device 20 in the configuration of the retargeting advertisement service system 1 is implemented as a computing device, the computer program 105 may include instructions for determining whether to generate RTB for a retargeting advertisement based on information regarding user groups transmitted from the bidding participation device 30.

In one embodiment, when the bidding participation device 30 in the configuration of the retargeting advertisement service system 1 is implemented as a computing device, the computer program 105 may include additional instructions for performing RTB when an advertisement media generation event occurs on a first terminal belonging to a user group for which RTB generation has been determined by the bidding generation device 20.

At this time, the computer program 105 may include instructions for the operation of calculating the user behavior conversion probability and the success probability of the RTB at a first terminal using advertisement access history, near-future transmission information, and user profile information stored in the advertisement targeting server 10.

Thus far, various embodiments of the present invention and their effects have been described with reference to FIGS. 1 through 9. The effects according to the technical scope of the present invention are not limited to the effects mentioned above, and other effects not mentioned may be clearly understood by those skilled in the art from the description below.

The technical scope of the present invention described thus far may be implemented as computer-readable code on a computer-readable medium. The computer-readable recording medium may be, for example, a removable recording medium (CD, DVD, Blu-ray disc, USB storage device, removable hard disk) or a fixed recording medium (ROM, RAM, hard disk built into a computer). The computer program recorded on the computer-readable recording medium may be transmitted over a network such as the internet to other computing devices, installed on the other computing devices, and used on those devices.

While all components constituting the embodiments of the present invention have been described as being combined or operating in combination, the technical scope of the present invention is not necessarily limited to such embodiments. That is, within the scope of the present invention, all components may be selectively combined and operate in various configurations.

Although operations are illustrated in the drawings in a specific sequence, it should not be understood that the operations must be performed in the illustrated order, sequentially, or that all operations must be performed to achieve desired results. In certain circumstances, multitasking and parallel processing may be advantageous. Furthermore, the separation of various configurations described in the embodiments above should not be understood as mandatory, and it should be understood that the described program components and systems may generally be integrated into a single software product or packaged as multiple software products.

Although the embodiments of the present invention have been described with reference to the attached drawings, those skilled in the art will understand that the present invention may be embodied in other specific forms without changing its technical scope or essential characteristics. Therefore, the embodiments described above should be understood as illustrative rather than limiting in every respect. The scope of protection of the present invention should be interpreted according to the appended claims, and all technical concepts within equivalent scope should be interpreted as being included in the technical scope defined by the present invention.

What is claimed is:

1. A retargeting advertisement service method comprising:
collecting, by an advertisement targeting server, advertisement ID information and identification information from each of a plurality of terminals that have acquired an advertisement ID transmitted by a digital advertising medium;
performing, by a bidding participation device, clustering using the information collected by the advertisement targeting server and transmitting information regarding a user group of a size exceeding a threshold, generated as a result of the clustering, to a bidding generation device;
determining, by the bidding generation device, whether to generate real-time bidding (RTB) for a retargeting advertisement for the transmitted user group, based on the information regarding the transmitted user group; and
performing, by the bidding participation device, the RTB when an advertisement media generation event occurs on a first terminal belonging to the user group.

2. The retargeting advertisement service method of claim 1, wherein
the collecting the advertisement ID information and the identification information from each of the plurality of terminals that have acquired an advertisement ID transmitted by the digital advertising medium further comprises collecting additional information generated during movement of each of the plurality of terminals, and
the additional information includes whether a single or multiple predetermined advertisement IDs have been acquired, location information and time information at which the advertisement IDs have been acquired, and user profile information.

3. The retargeting advertisement service method of claim 2, wherein
the additional information includes location information of the digital advertising medium, advertisement transmission history information, advertisement transmission timing information, information on effective points for viewing advertisements, and movement trajectory information of a user of each of the terminals.

4. The retargeting advertisement service method of claim 2, wherein the performing clustering using the information collected by the advertisement targeting server and transmitting information regarding a user group of a size exceeding a threshold, generated as a result of the clustering, to the bidding generation device, comprises: performing clustering into a plurality of user groups based on the advertisement ID information, the identification information, and the additional information; and determining a user group of a size exceeding the threshold among the clustered user groups.

5. The retargeting advertisement service method of claim 1, wherein the digital advertising medium includes a display mounted on mobility.

6. The retargeting advertisement service method of claim 1, wherein the performing the RTB when an advertisement media generation event occurs on the first terminal belonging to the user group, comprises performing the RTB when an application execution or website access event occurs on the first terminal in accordance with user action.

7. The retargeting advertisement service method of claim 1, wherein the performing the RTB when an advertisement media generation event occurs on the first terminal belonging to the user group, comprises transmitting, by the bidding participation device, a push notification to the first terminal to induce the occurrence of the advertisement media generation event.

8. The retargeting advertisement service method of claim 1, wherein the performing the RTB when an advertisement media generation event occurs on the first terminal belonging to the user group, comprises: receiving, by the bidding participation device, advertisement access history, near-future transmission information, and user profile information of the first terminal stored in the advertisement targeting server; and calculating, using the received information, a user behavior conversion probability and RTB success probability at the first terminal.

9. The retargeting advertisement service method of claim 8, wherein the advertisement access history includes advertisement access frequency and advertisement access timestamp information corresponding to a movement path of the first terminal.

10. The retargeting advertisement service method of claim 8, wherein the user behavior conversion probability is a probability of occurrence of a click event, a download event, and a purchase conversion event for an advertisement provided through an application or website on the first terminal.

11. The retargeting advertisement service method of claim 1, wherein the performing the RTB when an advertisement media generation event occurs on the first terminal belonging to the user group, comprises: receiving requirements of an advertiser participating in the RTB; and selecting and providing a retargeting advertisement that meets the advertiser's requirements.

12. The retargeting advertisement service method of claim 11, wherein the advertiser's requirements include information regarding a user's gender, age group, areas of interest, types of applications installed by the user, a time of last application execution, and a list of products recently purchased by the user.

13. A retargeting advertisement service system comprising:
an advertisement targeting server collecting advertisement ID information and identification information from each of a plurality of terminals that have acquired an advertisement ID transmitted by a digital advertising medium;
a bidding participation device performing clustering using the information collected by the advertisement targeting server and transmitting information regarding a user group of a size exceeding a threshold, generated as a result of the clustering, to a bidding generation device; and
the bidding generation device determining whether to generate real-time bidding (RTB) for a retargeting advertisement for the transmitted user group, based on the information regarding the transmitted user group,
wherein the bidding participation device performs the RTB when an advertisement media generation event occurs on a first terminal belonging to the user group.

14. The retargeting advertisement service system of claim 13, wherein
the advertisement targeting server collects additional information generated during movement of each of the plurality of terminals, and
the additional information includes whether a single or multiple predetermined advertisement IDs have been acquired, location information and time information at which the advertisement IDs have been acquired, and user profile information.

15. The retargeting advertisement service system of claim 14, wherein the bidding participation device performs clustering into a plurality of user groups based on the advertisement ID information, the identification information, and the additional information, and determines a user group of a size exceeding the threshold among the clustered user groups.

16. The retargeting advertisement service system of claim 13, wherein the bidding participation device performs the RTB when an application execution or website access event occurs on the first terminal in accordance with user action.

17. The retargeting advertisement service system of claim 13, wherein the bidding participation device transmits a push notification to the first terminal to induce the occurrence of the advertisement media generation event.

18. The retargeting advertisement service system of claim 13, wherein the bidding participation device receives advertisement access history, near-future transmission information, and user profile information of the first terminal stored in the advertisement targeting server, and calculates, using the received information, a user behavior conversion probability and an RTB success probability at the first terminal.

19. The retargeting advertisement service system of claim 18, wherein the advertisement access history includes advertisement access frequency and advertisement access timestamp information corresponding to a movement path of the first terminal.

20. The retargeting advertisement service system of claim 18, wherein the user behavior conversion probability is a probability of occurrence of a click event, a download event, and a purchase conversion event for an advertisement provided through an application or website on the first terminal.
